(19) United States
(12) Patent Application Publication
(10) Pub. No.: US 2025/0299475 A1
(43) Pub. Date: Sep. 25, 2025

(54) AUTOMATED ASSESSMENT OF MACHINE LEARNING MODELS USING SYNTHESIZED DATA WITH DIFFERENT CONTEXTS

(71) Applicant: SiMa Technologies, Inc., San Jose, CA (US)

(72) Inventors: Ching Yee Hu, San Jose, CA (US); S.R. Prakash, Saratoga, CA (US)

(21) Appl. No.: 19/087,069

(22) Filed: Mar. 21, 2025

Related U.S. Application Data
(60) Provisional application No. 63/568,957, filed on Mar. 22, 2024.

(51) Int. Cl. G06V 10/776; G06V 10/70; G06V 10/774; G06V 10/86

(52) U.S. Cl. CPC G06V 10/776; G06V 10/768; G06V 10/7753; G06V 10/86

(57) ABSTRACT

To assess a machine learning (ML) model for possible inaccuracies, different, synthesized trial scenes are applied to the ML model. Each trial scene includes a target object of interest, plus different surrounding contexts. The ML model takes the scenes as input and makes a corresponding prediction. The prediction is affected by both the target object and the surrounding context. The synthesis of many trial scenes with different contexts allows an assessment of the effect of different contexts on the ML prediction. The predictions and corresponding contexts are analyzed to assess the behavior of the ML model. For example, assume that the ML model has some sort of inaccuracy that shows up in some trial scenes but not others. The contexts for the trial scenes with the inaccuracy may be compared with the trial scenes without the inaccuracy.

### CROSS-REFERENCE TO RELATED APPLICATION(S)

This application claims priority under 35 U.S.C. § 119 (e) to U.S. Provisional Patent Application Ser. No. 63/568,957, “Automated Machine Learning Behavior Assurance Through Synthesized Data,” filed Mar. 22, 2024. The subject matter of all of the foregoing is incorporated herein by reference in its entirety.

### BACKGROUND

### 1. Technical Field

This disclosure relates generally to machine learning, and more particularly, to the automated assessment of machine learning models.

### 2. Description of Related Art

One of the advantages of machine learning is that models can be trained to accomplish tasks that are otherwise difficult to perform. This can be done without having to expressly code the logic applied by the model and without expressly understanding the final logic implemented by the trained model. However, this is also one of the disadvantages of machine learning. Without expressly knowing what logic is implemented by the trained model, it can be difficult to determine whether the model will provide accurate predictions in all scenarios.

In addition, once a machine learning (ML) model has been trained, it is then deployed in the field. The original trained model may go through a number of transformations (e.g., quantization) before being deployed on a hardware system, such as an edge device. The edge device may not have the same compute resources or battery life as the server farm used to train the original model. The quantization may reduce the computational burden, memory capacity or network bandwidth used by the ML model so that the quantized model is more suitable for use on edge devices. However, this quantization may further reduce the accuracy of the model.

There currently are no standard workflows for model failure analysis or risk assessment, whether to detect inaccuracies in the original trained model or to detect model degradation introduced by quantization of the deployed model. For many applications, including those that interact with humans or impact human safety, having an assurance in failure and risk assessment in the deployed model is a requirement. Existing solutions may involve rapid patching of detected defects or building redundant systems to double check the ML model. However, these solutions address the symptom and not the root cause of inaccuracies.

### BRIEF DESCRIPTION OF THE DRAWINGS

Embodiments of the disclosure have other advantages and features which will be more readily apparent from the following detailed description and the appended claims, when taken in conjunction with the examples in the accompanying drawings, in which:

FIG. 1 is a flow diagram of automated model assessment using synthesized scenes.

FIG. 2 is a block diagram of a system for automated model assessment using synthesized scenes.

FIG. 3 is a flow diagram for determining future trial scenes.

FIG. 4A is a scene illustrating detecting incorrect contexts with labeled contexts.

FIG. 4B is a knowledge graph of relationships between the objects of FIG. 4A.

FIG. 5 is a diagram for detecting incorrect contexts without labeled contexts.

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Aspects of the present disclosure relate to the automated assessment of ML models using synthesized data with different contexts. The concepts will be explained using ML models that take scenes (e.g., static images or video) as inputs and generate image analysis predictions relating to objects in the scene. For example, the ML model may make predictions relating to object detection of a target object in a scene, object classification of the target object, attribute extraction for the target object, generating a bounding box for the target object. Semantic segmentation, instance segmentation, depth estimation, behavior prediction, intent recognition, scene understanding, and anomaly detection are other examples of image analysis predictions. The principles illustrated are not limited to these ML models. They may also be applied to ML models that take other types of data as inputs and/or make other types of predictions as output.

To assess the ML model for possible inaccuracies, different, synthesized trial scenes are applied to the ML model. Each trial scene includes the target object of interest, plus different surrounding contexts. For example, there may be a baseline scene that includes the target object plus many other objects (the baseline context). The trial scenes may be synthesized by combining the target object with different permutations of the other objects.

The ML model takes the scene as input and makes a corresponding prediction. The ML model makes predictions for each of the trial scenes with different contexts. The prediction is affected by both the target object and the surrounding context. The synthesis of many trial scenes with different contexts allows an assessment of the effect of different contexts on the ML prediction. The predictions and corresponding contexts are analyzed to assess the behavior of the ML model. For example, assume that the ML model has some sort of inaccuracy that shows up in some trial scenes but not others. The contexts for the trial scenes with the inaccuracy may be compared with the trial scenes without the inaccuracy. In this way, the cause of the inaccuracy may be determined and addressed.

In another aspect, the trial scenes may be synthesized by using text-to-image rendering. For example, the baseline scene may be described using a text format. The text scene definition may include text labels for different objects in the scene and text descriptors for different attributes and relationships between objects. Different permutations of this text scene definition may be generated, for example by omitting different objects and the corresponding descriptors. These text scene definitions may then be synthesized into the trial scenes. In yet another aspect, a knowledge graph of relationships in the baseline scene may also be used to identify inaccuracies in the predictions generated by the ML model.

These approaches can be used to map out the weaknesses or unknown-unknown behaviors of a ML model using a scalable automated workflow. Unknown-unknown behaviors are inaccuracies in the ML model which are not apparent. For example, the ML model may make the right predictions for certain scenes, but for the wrong reason. As another example, the ML model may have been trained using a target object in certain surrounding contexts, but the training set may not be broad enough to cover all contexts encountered by the deployed model. One particular use scenario is to detect inaccuracies introduced by quantizing a ML model. The performance of the trained model before quantization may be compared to that of the model after quantization.

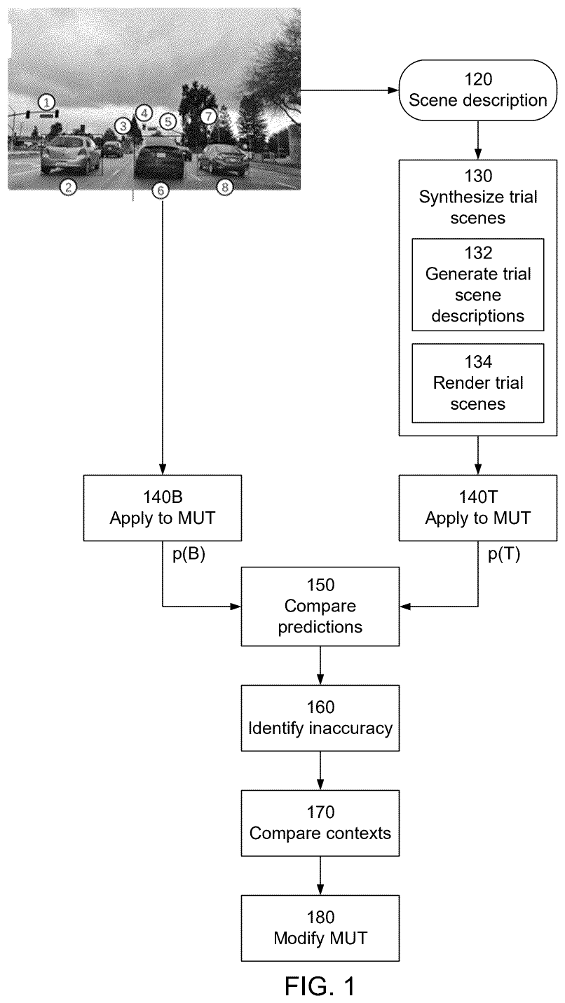

FIG. 1 is a flow diagram of automated ML model assessment using synthesized scenes. In this example, the baseline scene 110 shows traffic at an intersection. The scene 110 includes many different objects, labeled as 1,2,3, . . . . The ML model has been trained to make different predictions. The prediction being assessed in FIG. 1 is that the ML model has been trained to predict that object 3 is classified as a traffic light. The assessment is made by synthesizing different trial scenes that combine the target object 3 with different permutations of the other objects {1,2,4,5, . . . } and analyzing the corresponding predictions made by the ML model.

In this example, the baseline scene 110 is a captured image from the real world, and the trial scenes are synthesized from the baseline. However, in other cases, the baseline scene 110 may also be synthesized. The scene description 120 is a text description of the baseline scene 110 using a formal descriptive language. It is a natural language human readable textual description. Human readable text, including non-English characters, may include 7-bit ASCII, extended 8-bit ASCII, UTF-8, UTF-16, UTF-32, and ISO 8859 series character set. The description may be based on a simple key-value structure such as a JSON file. Examples of other formats include OpenScenario and OpenODD.

At 130, different trial scenes are synthesized. The trial scenes include the target object 3 in different surrounding contexts. For example, trial scenes may include objects {3}, {1,3}, {1,2,3}, {1,2,3,4}, {1,3,4}, {2,3}, {2,3,4}, {3,4}, etc. The order for generating and evaluating trial scenes can be defined by the user or based on a preference or goal. The permutations can be exhaustive based on the scene's labels. In FIG. 1, the scene synthesis is based on text-to-image rendering. At 132, the text scene descriptions for different trial scenes are generated based on different permutations of the components in the baseline scene description 120. At 134, these trial scene descriptions are rendered into the actual trial scenes.

At 140, the different scenes are applied as input to the ML model under test (MUT). At 140B, the baseline scene is applied. At 140T, the trial scenes are applied. The MUT generates predictions p, which in this example is the classification of target object 3. Other examples of image analysis predictions include object detection, object classification, attribute extraction, and bounding box generation.

In this example, the prediction p (B) from the baseline scene is taken as the ground truth. At 150, the ground truth from the baseline prediction p (B) is compared to the predictions p (T) for the trial scenes. A standard metric used for defined Operational Design Domain (ODD) or scenario can be used. Examples of metrics include accuracy-based metrics (mean squared error (MSE), root mean squared error (RMSE), final displacement error (FDE), average displacement error (ADE)); probabilistic metrics (negative log-likelihood (NLL), Brier score, entropy of distribution) and diversity and coverage metrics (miss rate (MR), minimum overlap rate (MOR), multi-modal coverage (MMC)). There are many trial predictions p (T), which correspond to the different trial scenes with different contexts. The trial predictions p (T) are used to enable traceability and explainability of which other objects impact the classification of target object 3.

At 160, inaccuracies in generating the trial predictions are identified, based on the predictions and the corresponding contexts for different trial scenes. One type of inaccuracy is an inaccurate prediction. For example, target object 3 should be classified as a traffic light, but it is classified as a building window in certain trial scenes. Another type of inaccuracy is that the prediction, even if correct, is based on an incorrect context. For example, target object 3 is correctly classified as a traffic light, but the classification depends heavily on the presence of background clouds (because, in the original training set, traffic lights often had background clouds).

Additional information may be used to identify inaccuracies. For example, a knowledge graph of the relationships between objects in the baseline scene may be available. The information in the knowledge graph may be used to identify inaccuracies in generating the trial predictions.

At 170, the contexts for trial scenes with and without the inaccuracy are compared. For example, the objects in the trial scenes that correctly classify target object 3 as a traffic light may be compared with the objects in the trial scenes that did not correctly classify target object 3. These comparisons can provide insight into which of the surrounding objects may be causing any inaccuracy.

At 180, the MUT is modified based on this comparison. For example, if certain objects are identified as good indicators of the inaccuracy, the MUT may be modified based on this information. Different steps may be taken to improve the MUT. For example, further training may be applied to address the inaccuracy. This may be based on samples already existing in the training set (e.g., traffic lights without background clouds). It may also include generating new training samples to address the inaccuracy. Other types of modifications include changes to the MUT architecture and/or modifications to the quantization of the model.

In some cases, the assessment of the MUT may be quantized by a risk score indicative of the inaccuracy. As an example of a domain-specific weighted risk factor, consider the following. For an autonomous vehicle, a false negative (not detecting a pedestrian) could have a much higher weight than a false positive (detecting a pedestrian when none is present), because the consequences of a false negative are more significant. The risk score could be the weight of each case multiplied by the detection value (i.e. 0 for not detect, and 1 for detect) for the two cases (false negative, false positive).

The process shown in FIG. 1 may be repeated for many different baseline scenes, many different synthesized trial scenes, and many different ML predictions. It may continue in iterations until a satisfactory performance is achieved.

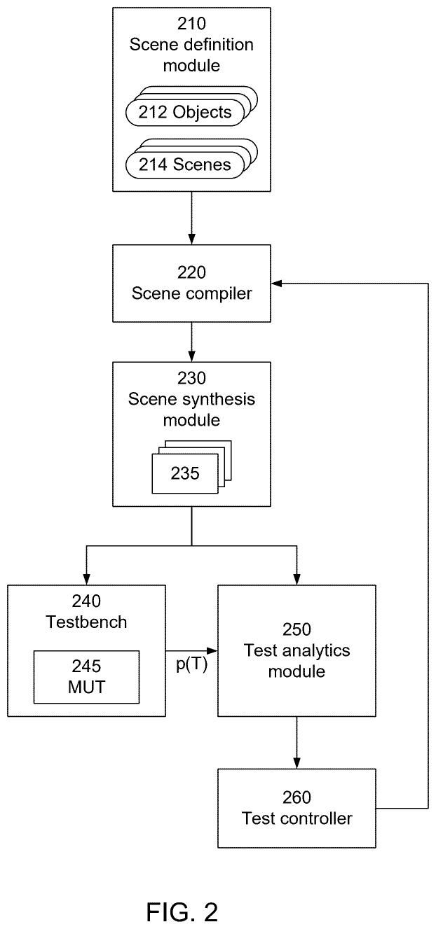

FIG. 2 is a block diagram of a system for automated model assessment using synthesized scenes. The system includes a scene definition module 210, a scene compiler 220, a scene synthesis module 230, a testbench 240 for testing the MUT 245, a test analytics module 250, and a test controller 260. The modularized functional blocks depicted in FIG. 2 represent a high level description of the functional modules. Each module can be implemented using software tools with interfaces between the modules. Each of the modules can be developed independently and there can be many different implementations for each module.

The scene definition module 210 includes the entities (objects), scene composition, actions, and relationships that are used to synthesize the trial scenes, which can be photorealistic scenes, static images and/or videos. In FIG. 2, the scene definition module 210 includes components that define different objects 212 and also different scenes 214 that include those objects. Given the inevitable ambiguity of using written language to describe a complex visual scene, the amount of detail and description can vary depending on the level of creativity or imagination that can be tolerated at the scene synthesis stage.

In the example of FIG. 2, objects 212 and scenes 214 are each defined as a key-value pair as defined by the JSON file format. An example JSON code block defining a simple scene is shown in Listing 1 below. Other more complex standards such as OpenODD or OpenScenario may also be used. In some cases, these standards are transformed into a JSON file for import by the scene compiler 220.

### Listing 1: Example Scene Definition

{
   “Object: SUV”: “midsize silver SUV”,
   “Object: pickup”: pickup truck with stuff in the truck bed”,
   “Object: coffee shop”: “Coffee shop with people sitting outside the shop”,
   “Scene: city traffic jam”: {
      “SUV”: “Object: black SUV”,
      “Pickup”: “Object: white pickup”,
      “Coffee shop”: “Object: coffee shop”,
      “Pedestrians”: “people crossing the street”,
      “lighting condition”: “facing morning sun”
   }
}

The scene compiler 220 takes a set of defined objects and scenes and builds these into a text prompt that the scene synthesis module 230 can render into a scene. The compiler functionality depends on the actual text-to-image/video scene synthesis ML model 235 used for scene synthesis 230. For example, the compiler 220 may add specific key words or phrases along with guidance strength, iteration number, random seed, and other factors that are coupled to the specific synthesis ML model 235. Multiple iterations may be used to find the best fitting synthesized scene for use.

Scene compilation 220 may be defined in part by configuration instructions. The scene configuration may be in the form of a YAML file, which serializes the data structures required to compile a scene description appropriate for the specific synthesis ML model 235 downstream. There can be different scene configuration instructions for different downstream synthesis ML models 235.

The scene synthesis module 230 couples the output of the scene compiler 220, which generates a specific set of text prompts, and feeds it into one or more text-to image or video frame synthesis ML models 235. The output of this module 230 is fed both to the testbench 240 for application to the MUT and also to the test analytics module 250.

The scene synthesis module may be configured for each model 235's inference parameters, which can be serialized in a YAML file or other means. Example synthesis models 235 include Stable Diffusion, DALL-E, MidJourney, or other GAN-based models. Example configuration parameters for these models 235 may include:
Sampling parameters: sample method, temperature, top-k sampling, top-p sampling
Guidance scale
Resolution
Denoising strength
Seed value
Step count
Latent space parameters: latent noise, embedding size, or specific vectors for image generation A set of trial scenes can be rendered based on the scene synthesis configuration and the received text descriptions of the trial scenes.

The testbench 240 applies the trial scenes as input to the MUT 245, which generates the corresponding predictions p (T).

The test analytics module 250 assesses the MUT. It identifies and analyzes inaccuracies in generating the ML predictions p (T). There are numerous methods for qualitative and quantitative ML model analysis. These methods can be selected and configured in an analytics configuration file, such as a YAML file. This module 250 may also produce a metric to quantify model behavior. This stage can also help identify weakness or failures in the classification. As such, the classification confidence percentage is an important parameter.

Inaccuracies can include the following:
Incorrectly labeled entity or incorrect classification
Bounding box position or size differential beyond threshold of correct bounding box
Low score in predicted class
Correct prediction but based on incorrect context

For the last item, to determine if incorrect context is used, the system must determine what within the surrounding context is influencing the prediction. It may do this by comparing the surrounding contexts in the trial scenes with inaccuracy, and the surrounding contexts in the trial scenes without inaccuracy.

Context is “learned” by the ML model through the training cycle, and thus it is incorporated into the ML weights, but not in a way that is understandable by humans. If context can be understood or correlated, such as by the comparisons of trial scenes with different contexts, then there is a direct evidence of failure origin and risk mapping to a ML model's “rationality.” This is an important step toward safety assurance of an ML model.

In one example, the output of the ML model identifies the region of interest within the scene to focus on and renders only the objects within the region of interest. The background scene could be maintained, unless the background object has labels as well and has been classified as an object to be removed.

Based on the analysis, the test analytics module 250 may determine additional trial scenes for future iterations. An example general structure for the output from the analytics stage 250 is shown in Listing 2 below. This is passed on to the test controller 260, which configures the information needed by the scene compiler 220.

### Listing 2: Example Next Test Configuration

{
   “Objects to render”: {
      “Object 1”: “objectID or bounding box coordinate”, “Object N”: “ . . . ”
   },
   “Object to not render”: {
      “Object x”: “objectID or bounding box coordinate”, “Object M”: “ . . . ”
   },
   “Render background”: “yes=render, no=not render”,
   “Scene crop dimension”: “upper left corner x and y coordinates, lower right corner x and y coordinates”,
   “Continue iteration”: “yes=continue iteration, no=end test”
}

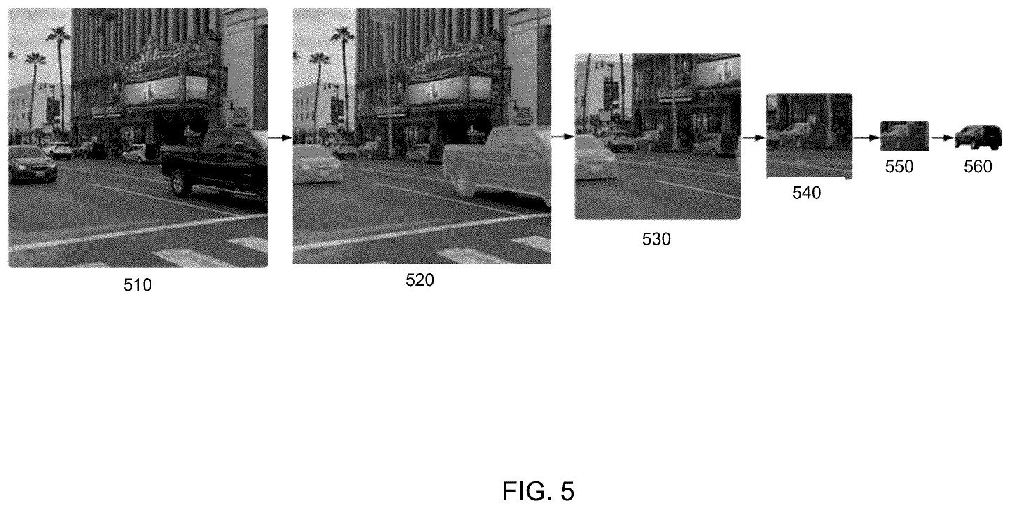

The test controller 260 receives the output of the test analytics module 250, for example Listing 2 above. Based on this, the test controller 260 provides instructions to the scene compiler 220 to determine the scene configuration for the next iteration of test. This module 260 could also determine the crop size, if any, of the next test's image frame (as shown below in FIG. 5). If no crop is to be used, only objects defined by the permutation would be rendered, and the rest are removed according to the definition as shown in example Listing 2.

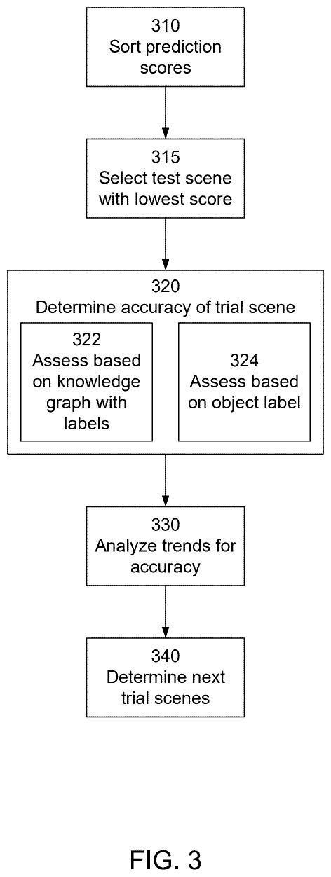

FIGS. 3-5 are examples of analysis that may be performed by test analytics module 250. FIG. 3 is a flow diagram for determining future trial scenes. At 310, the prediction scores from the MUT for the current trial scenes are sorted. At 315, the trial scene with the lowest score for the target object is selected. At 320, the accuracy of the selected trial scene is assessed. FIG. FIG. 3 shows two different ways to determine accuracy. At 322, if a knowledge graph based on labels exists, then the accuracy may be assessed based on the knowledge graph. Otherwise, at 324, the accuracy may be assessed based on the label of the target object. At 330, the accuracy result is added to the accumulated accuracy data points and trends for the accuracy can be analyzed. For example, did the accuracy suddenly drop? Or is it trending worse rapidly? Or is it improving? At 340, these trends are used to determine the next trial scenes to be rendered.

If the contexts are labelled, incorrect contexts may be discovered as follows. Given all the classes that a ML model supports, i.e. a list of all the classes or entities that are labeled in the training data set, triplets of node-edge-node can be developed based on these classes. The nodes are the different classes, and the edges are the relationships between classes. The resulting triplets can be visualized as a knowledge graph with one or more clusters of related nodes. This knowledge graph can be thought of as capturing the common sense or rationality for the scene. Some examples of common sense include the following: pigs do not have wiper blade, horses do not have wheels, cars have wheels, etc. This is captured in the knowledge graph.

One can define a set of relationships based on the closed set of labels from the training data set. In this case, the relationship defined is exhaustive because the label is a closed set, and there are only a finite number of rational relationships. This knowledge graph can be generated using a LLM model and verified by human experts, or created manually. The end result is a file containing a representation of the knowledge graph of the labels. The representation can be in the form of knowledge graph embedding or triplets, but other forms may also exist.

To map out an incorrect context in the prediction, permutations of different objects are generated, as depicted in FIG. 1. Then, the set of objects that provide the highest prediction score, but with the highest number of object not related to the target object, is identified. This relationship check is a simple graph traversal for the target object to see if the other objects are somehow in the connected network. If the relationship does not exist, then remove the unrelated objects in the permutation and check if the prediction has changed. Keep iterating until the prediction has changed or prediction score is below a threshold. The previous removed object(s) would be primary suspects as a high influencer for the prediction.

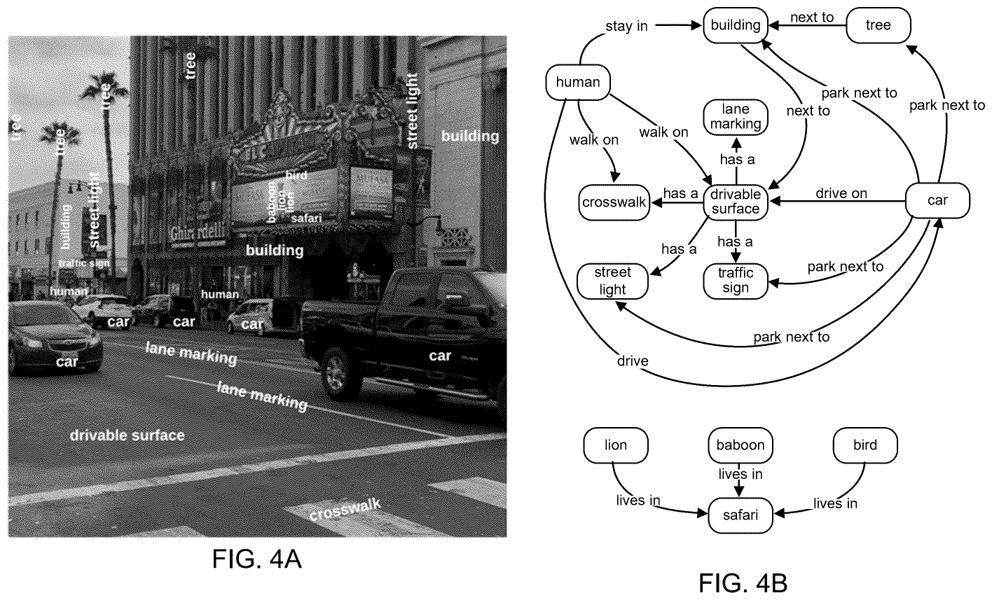

Consider the example shown in FIGS. 4A and 4B. FIG. 4A shows a scene with different objects labeled. FIG. 4B shows a knowledge graph of the objects labeled in FIG. 4A. Assume the object of interest for classification is “car” in FIG. 4. Also assume that “car” is classified correctly, but after several iterations of different trial scene permutations, it was determined that the primary influencing factor on the classification is the “lion” in the building's sign. From the knowledge graph of FIG. 4B, “lion” is not related to “car.” In this case, a potential inaccuracy in the model behavior was identified. This information would be used by the test analytics module 250 to generate the scene description for the next trial scene.

If the contexts are not labelled, incorrect contexts may be discovered as follows. In this case, a multi-state cropping method can be employed to staged elimination of context until the target object is the only item remaining in the scene, as illustrated in FIG. 5. In FIG. 5, the original scene 510 includes a parked minivan as the target object. At 520, the target object is identified and masked using a geometry-preserving mask segmentation method such as polygon fitting or convex hull approximation. Other detected objects within the scene can also be identified with the same method, as indicated by the color masks in 520. Each stage 530-560 is processed through the MUT, and a scored classification result is produced. The output of each stage will be a data point that shows convergence or divergence of the target object classification score. Each data point will help identify the failure origin and thus map out the unknown risks within the ML model. The score differential between crops 530-560 for the target object may be used as an indicator of potential inaccuracy and pushed to the next test iteration run.

Although the detailed description contains many specifics, these should not be construed as limiting the scope of the invention but merely as illustrating different examples. It should be appreciated that the scope of the disclosure includes other embodiments not discussed in detail above. Various other modifications, changes and variations which will be apparent to those skilled in the art may be made in the arrangement, operation and details of the method and apparatus disclosed herein without departing from the spirit and scope as defined in the appended claims. Therefore, the scope of the invention should be determined by the appended claims and their legal equivalents.

What is claimed is:

1. A computer-implemented method for assessing a machine learning model, the method comprising:
synthesizing a plurality of trial scenes comprising a target object in different surrounding contexts;
applying the trial scenes as input to a machine learning model under test (MUT), wherein the MUT generates image analysis predictions for the target object based on the trial scenes with different surrounding contexts;
identifying an inaccuracy in generating the MUT predictions, based on the generated predictions and the corresponding contexts for different trial scenes;
comparing (a) the surrounding contexts in the trial scenes with the inaccuracy, with (b) the surrounding contexts in the trial scenes without the inaccuracy; and
modifying the MUT based on the comparison of the surrounding contexts.

2. The computer-implemented method of claim 1 wherein the identified inaccuracy is an inaccurate prediction.

3. The computer-implemented method of claim 1 wherein the identified inaccuracy results from an incorrect context.

4. The computer-implemented method of claim 3 wherein the surrounding contexts are labeled.

5. The computer-implemented method of claim 3 wherein the surrounding contexts are unlabeled.

6. The computer-implemented method of claim 1 wherein comparing the surrounding contexts comprises identifying which components of the surrounding contexts are indicators of the inaccuracy, and modifying the MUT is based on the identified indicators.

7. The computer-implemented method of claim 1 wherein:
a baseline scene comprises the target object in a baseline context containing multiple surrounding objects; and
the plurality of trial scenes comprise combinations of the target object with different permutations of the surrounding objects.

8. The computer-implemented method of claim 7 wherein comparing the surrounding contexts comprises identifying which of the surrounding objects are indicators of the inaccuracy, and modifying the MUT is based on the identified indicators.

9. The computer-implemented method of claim 7 wherein identifying the inaccuracy is further based on comparison to a baseline prediction generated by the MUT for the baseline scene.

10. The computer-implemented method of claim 7 wherein the baseline scene is described by a text scene definition; and synthesizing the plurality of trial scenes comprises:
generating text scene definitions for the trial scenes based on permutations of the text scene definition for the baseline scene; and
rendering the trial scenes from the generated text scene definitions.

11. The computer-implemented method of claim 7 wherein identifying the inaccuracy is further based on a knowledge graph of relationships between objects in the baseline scene.

12. The computer-implemented method of claim 1 wherein the image analysis prediction for the target object includes at least one of: object detection of the target object, object classification of the target object, attribute extraction for the target object, and generating a bounding box for the target object.

13. The computer-implemented method of claim 1 wherein modifying the MUT comprises:
further training the MUT to address the identified inaccuracy.

14. The computer-implemented method of claim 1 wherein the MUT was generated by quantizing an initial machine learning model, and modifying the MUT comprises: modifying the quantizing of the initial machine learning model.

15. The computer-implemented method of claim 1 wherein the trial scenes include static images and/or videos.

16. The computer-implemented method of claim 1 further comprising:
quantifying the inaccuracy by producing a risk score indicative of the inaccuracy.

17. A non-transitory computer-readable storage medium storing executable computer program instructions for assessing a machine learning model, the instructions executable by a computer system and causing the computer system to perform a method comprising:
receiving a baseline data input;
identifying regions of interest (ROIs) in the baseline data input;
for a target ROI, synthesizing trial data inputs combining the target ROI with other ROIs;
applying the baseline data input and the trial data inputs to the machine learning model, the machine learning model producing a baseline prediction and trial predictions; and
comparing the baseline prediction and the trial predictions; and
evaluating the machine learning model based on the comparisons.

18. A computer system for assessing a machine learning model, the computer system comprising:
a scene synthesis module that synthesizes a plurality of trial scenes comprising a target object in different surrounding contexts;
a testbench that applies the trial scenes as input to a machine learning model under test (MUT), wherein the MUT generates image analysis predictions for the target object based on the trial scenes with different surrounding contexts; and
a test analytics module that identifies and analyzes an inaccuracy in generating the MUT predictions, based on the generated predictions and the corresponding contexts for different trial scenes; and
a test controller that determines which trial scenes to synthesize based on analysis from the test analytics module.

19. The computer system of claim 18 wherein:
a baseline scene comprises the target object in a baseline context containing multiple surrounding objects;
the plurality of trial scenes comprise combinations of the target object with different permutations of the surrounding objects; and
the test analytics module identifies which surrounding objects are indicators of the inaccuracy by comparing (a) the surrounding objects in the trial scenes with inaccuracy, and (b) the surrounding objects in the trial scenes without inaccuracy.

20. The computer system of claim 18 further comprising:
a scene definition module that provides text scene definitions for the trial scenes; and
a scene compiler that compiles the text scene definitions into a format that can be rendered by the scene synthesis module.
